(19) United States
(12) Patent Application Publication
(10) Pub. No.: US 2002/0185954 A1
(43) Pub. Date: Dec. 12, 2002

(54) Electrode of electron gun for cathode ray tube

(76) Inventor: Akihiro Nagase, Tokyo (JP)

Correspondence Address: BIRCH STEWART KOLASCH & BIRCH, PO BOX 747, FALLS CHURCH, VA, 22040-0747, US

(21) Appl. No.: 10/120,539

(22) Filed: Apr. 12, 2002

(30) Foreign Application Priority Data
Jun. 7, 2001 (JP) 2001-172556

(51) Int. Cl. H01J 29/50

(52) U.S. Cl. 313/414

(57) ABSTRACT

An in-line gun for a cathode ray tube includes three beam-passing holes formed in an electrode and at least two reference holes formed in the electrode. The three beam-passing holes are aligned in line. The two reference holes are positioned opposite to each other with respect to a middle beam-passing hole in the three beams-passing holes. The two reference holes are of different shapes. One of the two reference holes is a round hole and the other is an elongated hole. The elongated hole is formed by elongating a hole having a center located at a position opposite to that of the round hole toward the middle beam-passing hole. The elongated hole may be defined by combining a small-diameter hole, a large-diameter hole, and two lines tangent to the small-diameter hole and the large-diameter hole. The large-diameter hole is closer to the middle beam-passing hole than the small-diameter hole.

### BACKGROUND OF THE INVENTION

1. Field of the Invention

The present invention relates to an electron gun for a cathode ray tube (CRT), and more particularly to a shape of reference holes for positioning electrodes.

2. Description of the Related Art

An in-line gun for use in a CRT includes a three-electrode section that generates and accelerate three electron beams, and a lens section that focuses the three electron beams. The respective electrodes are formed with beam-passing holes and assembled so that the beam-passing holes for each beam are in line with one another.

FIG. 4 is a cross-sectional view of a pertinent portion of a conventional assembly jig used for assembling the electrodes of the electron gun. Referring to FIG. 4, a G1 electrode 1, a G2 electrode 2, a G3 electrode 3, a G4 electrode 4, a G5 electrode 5, and a G6 electrode 6 are aligned in this order. Sliding guide shafts 8a and 8b are mounted on a base 7. A movable frame 9 is movable on the sliding guide shafts 8a and 8b. Electrode-supporting members 10a and 10b extend through the electrodes 1-6 to support the electrodes 1-6. The electrode-supporting members 10a and 10b are removed from the electrodes 1-6 after the electrodes have finally been assembled together by using bead glass. Reference numerals 12a, 12b, and 12c denote beam-passing holes.

As shown in FIG. 4, the electrode-supporting members 10a and 10b are inserted into the beam-passing holes 12a and 12c, thereby positioning the electrodes 1-6 such that the beam-passing holes of the respective electrodes 1-6 for each beam are in line with one another. Spacers S1-S7 are placed between adjacent electrodes to position the adjacent electrodes with predetermined distances therebetween.

For minimum error in in-line alignment of the beam-passing holes for each beam, it is desirable that little or no difference exist between the diameter of the electrode-supporting members 10a and 10b and that of the beam-passing holes 12a, 12b, and 12c. In practice, a clearance of about several tens microns is usually allowed in order to accommodate dimensional errors associated with press work and ensure good assembly efficiency. Especially, errors in in-line alignment near the three-electrode section seriously affect the focussing and convergence performances, and therefore the clearances are closely controlled to a minimum.

The bead glass used for fixing the electrodes is usually heated to a temperature of 1600° C. so that the bead glass becomes softened and the electrodes can be inserted into the bead glass. During this process, heat is transferred from the bead glass to the electrodes so that the electrodes are temporarily heated to about 200° C. The bead glass is heated with the respective electrodes assembled together. The center-to-center distance of the beam-passing holes formed in each electrode becomes longer due to thermal expansion of the electrode. However, the jig that holds the electrode-supporting members 10a and 10b are not heated and therefore the distance between the electrode-supporting members remains unchanged regardless of heat transfer from the bead glass to the electrode, exerting stress on the thermally expanded electrode. In order to accommodate the thermal expansion of the electrodes, the electrode-supporting members are constructed to accommodate the thermal expansion of the electrodes, for example, a clearance is allowed between the electrode-supporting members and the electrode. Designing the electrode-supporting members to accommodate the thermal expansion maintains good in-line alignment of the beam-passing holes as well as minimizing deformation of the beam-passing holes due to mechanical stress and changes in the distance between electrodes due to distortion of the electrodes.

Recent increasing intensity and resolution of a CRT have placed stringent requirements on the assembly accuracy of an electron gun such as the in-line alignment of beam-passing holes among the electrodes and the distances between adjacent electrodes. In order to meet these requirements, some recent electrodes have been designed to have a thickness of 0.1 mm and a beam-passing hole of 0.15 mm in diameter.

For these reasons, a single conventional electrode-supporting member can no longer support a conventional lens section and a three-electrode section to place these parts in position. Especially, electrode-supporting member having a small diameter is generally not durable and therefore becomes expensive.

Japanese Patent Laid-open Publication No. 57-138750 discloses a separate reference-hole method in which the three-electrode section is formed with reference holes in addition to the beam-passing holes and the three electrodes are assembled together using an additional electrode-supporting member, and the lens section is assembled together using another electrode-supporting members.

FIG. 5 illustrates a conventional assembly jig used in the separate reference-hole method. Elements similar to those in FIG. 4 have been given the same reference numerals. A GM electrode Gm is a special electrode disposed between the G1 electrode (acceleration) and G2 electrode (focussing) and has beam-passing holes with a smaller diameter than the other electrodes. Electrode-supporting members 10c and 10d support the G3 electrode 3 to the G6 electrode 6. Electrode-supporting members 11a and 11b support the three-electrode section in position such that the beam-passing holes of the G1 electrode to G3 electrode are positioned in line with one another. The electrode-supporting members 11a and 11b have free end portions that are cylinders with a diameter of about 1.3 mm. The electrode-supporting members 11a and 11b are spaced apart by, for example, a center-to-center distance of 17 mm.

FIG. 3 is a front view, illustrating the three-electrode section.

Beam-passing holes 12a-12c and reference holes 13a and 13b are aligned in line, the beam-passing holes 12a-12c being positioned between the reference holes 13a and 13b. The reference holes 13a and 13b are of the same shape and are symmetrically spaced apart from the beam-passing hole 12b. The reference holes 13a and 13b have a somewhat larger diameter than the electrode-supporting members 11a and 11b. As is clear from FIG. 4, the electrode-supporting members 10a and 10b are inserted through the beam-passing holes from the G6 electrode side and support the G3 electrode 3 to G6 electrode 6 such that the beam-passing holes of the respective electrodes are in line with one another. The electrode-supporting members 11a and 11b extend through reference holes of the electrodes 1, 2, 3, and GM electrode. Thus, the GM electrode receives the electrode-supporting members 11a and 11b and the electrode-supporting members 10a and 10b, so that the members 11a and 11b are properly positioned relative to the members 10a and 10b.

The separate reference-hole method is advantageous in that the electrode-supporting members are not inserted into the beam-passing holes by nature and therefore the method can be applied to electron guns having beam-passing holes of any sizes and shapes. However, the separate reference-hole method is disadvantageous in that the electrode-supporting members are not directly inserted into the beam-passing holes but the separate electrode-supporting members are inserted into the reference holes. Therefore, the accuracy in in-line alignment of the beam-passing holes is determined by the dimensional errors of the beam-passing holes and the reference holes through which the separate supporting members are inserted.

One way of maintaining good in-line alignment of the beam-passing holes formed in the electrodes is to minimize the clearances between the electrode-supporting members and the reference holes. However, small clearances are apt to cause deformation of the electrodes in contact with the electrode-supporting members and warping of the electrodes due to thermal expansion.

Alternatively, the electrode-supporting members 11a and 11b for the three-electrode section may be designed such that the electrode-supporting members 11a and 11b accommodate the thermal expansion of the respective electrodes. However, such a design of the electrode-supporting members 11a and 11b requires not only polishing of a flat surface but also polishing of a cylindrical surface by the use of a lathe, thus presenting problems of manufacturing cost and machining accuracy. According to the reference holes disclosed in Japanese Patent Preliminary Publication No. 57-138750, if the outer beam-passing holes are asymmetrically positioned with respect to the middle beam-passing hole, the thermally expanded electrodes create a turning moment which in turn causes degradation of the in-line alignment of the beam-passing holes.

### SUMMARY OF THE INVENTION

An object of the invention is to provide a structure of electrodes in which beam-passing holes are accurately aligned.

A structure of electrodes that form an in-line gun for a cathode ray tube includes three beam-passing holes and at least two reference holes formed in the electrode. The three beam-passing holes are aligned in line. The two reference holes are positioned substantially opposite to each other with respect to a middle one of the beams-passing holes. The two reference holes are of different shapes. Preferably, a first one of the two reference holes is a round or circular hole and a second one of the two reference holes is an elongated hole.

The second one of the at least two reference holes may be defined by elongating another circular hole toward the middle beam-passing hole. The another circular hole and the first one of the at least two reference holes may have centers at a substantially equal distance from the middle beam-passing hole.

The elongated hole may also have a contour defined by a small-diameter hole, a large-diameter hole, and two lines tangent to the small-diameter hole and the large-diameter hole. The large-diameter hole is closer to the middle beam-passing hole than the small-diameter hole.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates an electron gun using a Gm electrode according to the first embodiment;

FIG. 2 is a front view of the Gm electrode;

FIG. 3 is a front view, illustrating the three-electrode section;

FIG. 4 is a cross-sectional view of a pertinent portion of a conventional assembly jig used for assembling the electrodes of an electron gun; and

FIG. 5 illustrates a conventional assembly jig used in the separate reference-hole method.

### DETAILED DESCRIPTION OF THE INVENTION

First Embodiment

A general construction of the electron gun according to the invention is much the same as that of the conventional electron gun. Embodiments will be described, by way of example, with respect to a GM electrode.

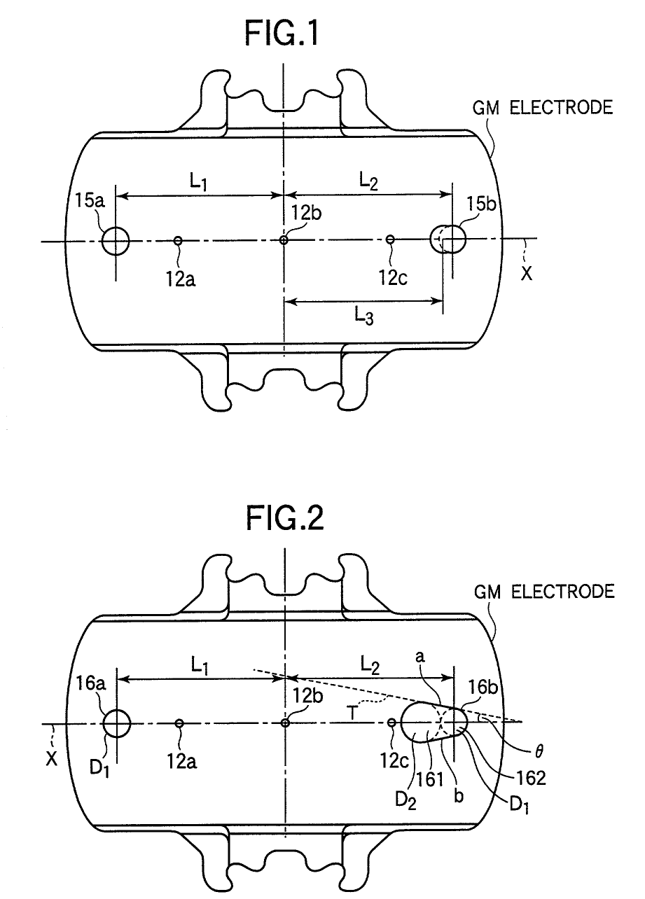

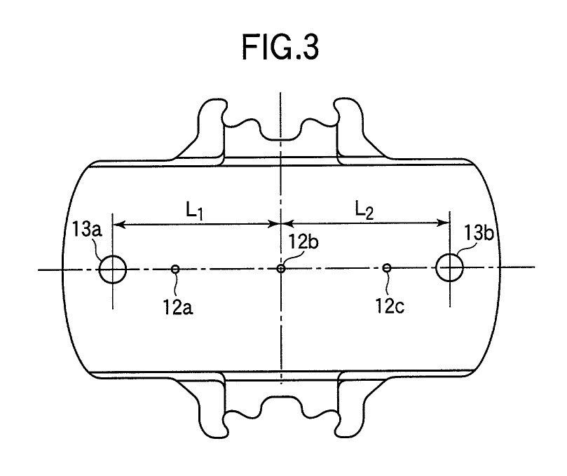

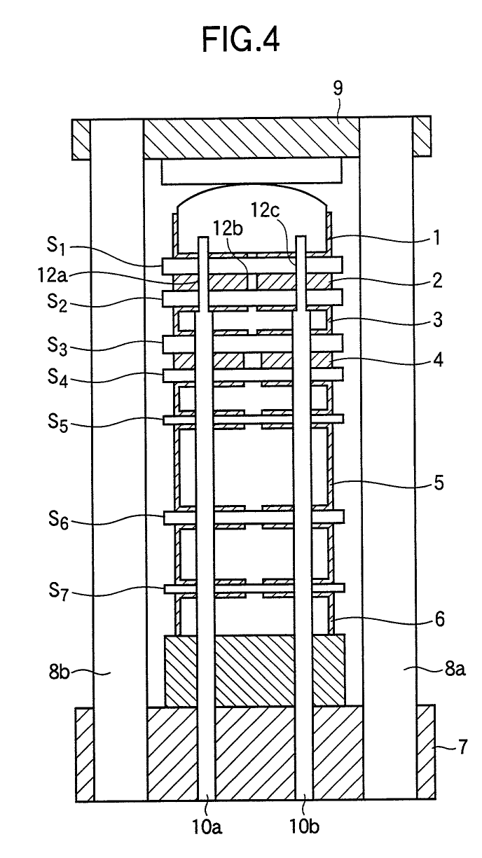

FIG. 1 illustrates an electron gun according to the first embodiment. The electron gun according to the invention employs a Gm electrode. Beam-passing holes 12a, 12b, and 12c and reference holes 15a and 15b are formed in the middle portion of the Gm electrode. The beam-passing holes 12a, 12b, and 12c and reference holes 15a and 15b are aligned in a row line such that the beam-passing holes 12a, 12b, and 12c are between the reference holes 15a and 15b. Thus, the reference holes 15a and 15b are positioned on the opposite sides of the beam-passing holes 12b. In this specification, the terms beam-passing holes 12a, 12b, and 12c are also used to cover the beam-passing holes formed in the respective electrodes.

The reference hole 15a is a circular hole formed at a distance of L1 from the central beam-passing hole 12b. The reference hole 15a has a diameter of 1.3 mm. Another reference hole 15b has a diameter of 1.3 mm and is elongated by 0.1 mm toward the central beam-passing hole 12b. In other words, the reference hole 15b is a elongated hole having two centers: one is at a distance L2 from the central beam-passing hole 12b and the other is at a distance L3 from the central beam-passing 12b. The distances L1 and L2 are the same and is equal to, for example, 8.5 mm, while the distance L3 is 8.4 mm. It should be noted that the reference hole 15a is a circular hole while the reference hole 15b is an elongated hole.

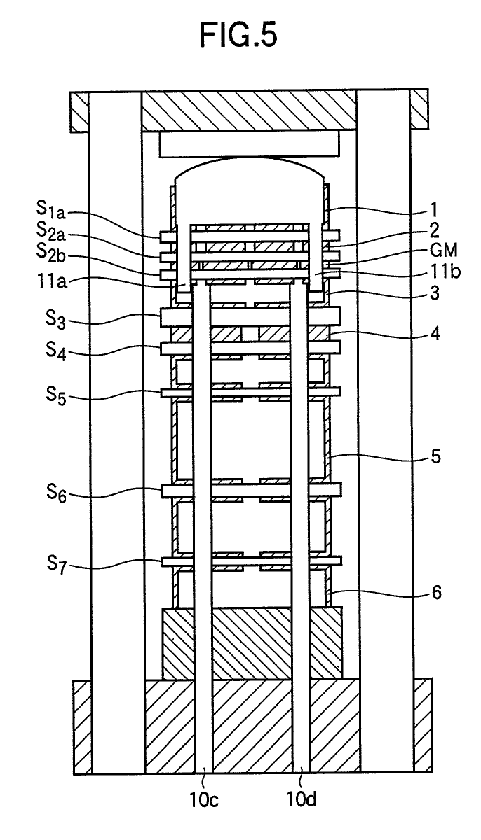

Just as in the separate reference-hole method described with reference to FIG. 5, the configured Gm electrode GM receives the electrode-supporting members 10c and 10d and the electrode-supporting members 11a and 11b for the three-electrode section, so that the Gm electrode is held in position. Then, the Gm electrode GM is fixed by the bead glass that is heated to soften. At this moment, the Gm electrode GM is also heated by the heat transferred from the bead glass. When the Gm electrode is heated, the Gm electrode thermally expands such that the distance between the holes increases. For example, if the Gm electrode is made of commonly used non-magnetic stainless steel and the reference holes formed in the Gm electrode are 17 mm spaced apart, the distance between the holes increases by about 45 μm when the Gm electrode is heated to 150° C.

A large clearance between the electrode-supporting member and a portion of the electrode that defines the beam-passing hole can prevent deformation of the entire electrode or at areas around the reference holes 15a and 15b or fracture of the electrode-supporting members. However, if the diameter of the reference hole exceeds the diameter of the electrode-supporting member by more than 45 μm, the beam-passing holes are not accurately aligned. Alternatively, if the circular portion of the reference hole 15b and the reference hole 15a have a diameter about ten to twenty microns larger than that of the electrode-supporting members 11a and 11b, the beam-passing holes 12a, 12b, and 12c can be sufficiently aligned in line with one another. Then, when the electrodes are heated during the assembly process of the electron gun, the elongated hole 15b allows the electrodes to contract and expand in a direction in which the hole 15b is elongated, preventing the electrodes from being deformed. The reference hole 15a do not move relative to the electrodes at elevated temperatures and therefore when the entire structure is cooled to room temperature, the electrodes are not moved relative to their initial positions before they are fixed by the bead glass.

Second Embodiment

FIG. 2 is a front view of the Gm electrode.

Referring to FIG. 2, the Gm electrode is formed of two reference holes 16a and 16b therein. The reference hole 16a is a circular hole and the reference hole 16b is an elongated hole defined by combining a small-diameter hole 162, a large-diameter hole 161, and two tangential lines a and b to the small-diameter hole 162 and large-diameter hole 161. FIG. 2 shows an electrode in which the large diameter hole 161 and the small diameter hole 162 are circumscribed, but the structure is not limited to this. The large diameter hole 161 is closer to the middle beam-passing holes 12b than the small diameter hole 162.

The lines a and b tangent to the large-diameter hole 161 and small-diameter hole 162 make an angle θ with the axis X on which the beam-passing holes 12a, 12b, and 12c are aligned. The reference hole 16a has a diameter D1 and the small-diameter hole 162 of the elongated hole 16b has a diameter D1 and the large-diameter hole 161 of the elongated hole 16b has a diameter D2. The angle θ is selected such that θ=tan⁻¹(d/(L1+L2)), providing that the diameter D2 is larger than D1 by d. The distance L1 is selected to be equal to the distance L2. When θ=tan⁻¹(d/(L1+L2)), the straight portion of the reference hole 16b will not touch the electrode-supporting members when the electrodes are thermally expanded, even if the electrode supporting members have been inserted in a twisted position.

As described above, the invention prevents degradation of in-line alignment of the beam-passing holes that may be encountered during the assembly of the electrodes, and minimizes the deformation of parts that may occur during the assembly of the electron gun particularly variations in distances between adjacent electrodes due to mechanical distortion of the parts.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. An electrode that form an in-line gun for a cathode ray tube, comprising:
a row of beam-passing holes; and
at least two reference holes, said at least two reference holes being positioned substantially opposite sides of a middle one of said beam-passing holes, said at least two reference holes being of different shapes.

2. The electrode according to claim 1, wherein a first one of said at least two reference holes is a circular hole and a second one of said at least two reference holes is a non-circular hole.

3. The electrode according to claim 1, wherein a first one of said at least two reference holes is a circular hole and a second one of said at lest two reference holes is an elongated hole.

4. The electrode according to claim 3, wherein the second one of said at least two reference holes is defined by elongating another circular hole toward the middle one of said beam-passing holes;
wherein the another circular hole and the first one of said at least two reference holes have centers at a substantially equal distance from the middle one of said beam-passing holes.

5. The electrode according to claim 3, wherein the elongated hole has a contour defined by a small-diameter hole, a large-diameter hole, and two lines tangent to the small-diameter hole and the large-diameter hole;
wherein the large-diameter hole is closer to the middle one of said beam-passing holes than the small-diameter hole.
